(19) United States
(12) Patent Application Publication
(10) Pub. No.: US 2006/0189322 A1
(43) Pub. Date: Aug. 24, 2006

(54) Method for admission control for mobile networks, an admission controller and a communication system therewith

(75) Inventors: Alberto Conte, Paris (FR); Philippe Dauchy, Paris (FR); Claudio Casetti, Torino (IT); Carla-Fabiana Chiasserini, Torino (IT)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/357,130

(22) Filed: Feb. 21, 2006

(30) Foreign Application Priority Data
Feb. 22, 2005 (EP) 05290415.8

(51) Int. Cl. H04Q 7/20

(52) U.S. Cl. 455/453

(57) ABSTRACT

The invention concerns a method for providing admission control for the admission of a mobile terminal (STA2) to a mobile network, whereby said admission control is based on at least one parameter (APP) that characterizes the radio channel that shall be used for a connection of the mobile terminal (STA2) to the mobile network and on at least one parameter (STAP) that characterizes the traffic flow of said connection, an admission controller (AC) and a communication system therewith.

The invention is based on a priority application EP 05290415.8 which is hereby incorporated by reference

### FIELD OF THE INVENTION

The invention relates to a method for providing admission control for the admission of a mobile terminal to a mobile network according to the preamble of claim 1, an admission controller according to the preamble of claim 6 and a communication system according to the preamble of claim 8.

### BACKGROUND OF THE INVENTION

The IEEE 802.11e standard provides Quality of Service (QoS) capabilities to Wireless Local Area Network (WLAN) systems by supporting traffic differentiation by means of Enhanced Distributed Channel Access (EDCA) mechanism, time-division multiplexing by means of Hybrid coordination function Controlled Channel Access (HCCA) mechanism, and means to request, release or modify network resources. The set of IEEE 802.11e tools promises to allow or ease the deployment of QoS-sensitive realtime and interactive services like Voice over Internet Protocol (VoIP) telephony and video streaming.

On the other hand, also admission control is a key building piece for QoS support. It is used to control network resources for QoS-constrained traffic. The admission control function accepts or rejects resource reservation requests based on network resource availability.

Unfortunately, while defining the messages to request, release or modify network resources, the IEEE 802.11e standard does not define a complete admission control mechanism, comprehensive of decision algorithm and means to estimate channel utilization.

Currently there are only either best effort solutions, which provide no QoS support, like in legacy IEEE 802.11a/b/g WLAN systems, or non-controlled solutions based on traffic differentiation using e.g. EDCA mechanisms, for the access to the network resources available.

In case of solutions based on traffic differentiation like e.g. EDCA mechanisms, the network resources are used by the terminals without control. The use of priorities brings effective traffic differentiation (e.g. voice with higher priority than web traffic), but the lack of resource control does not protect such solutions from network, i.e. radio channel, saturation. The main problem is, that a newly activated traffic flow, e.g. a voice call, can impact all already existing (active) streams like e.g. voice calls by degrading the overall satisfaction of the full set of users/customers of the WLAN system.

The object of the invention is to propose a solution for providing admission control for the admission of a mobile terminal to a mobile network.

This object is achieved by a method according to the teaching of claim 1, an admission controller according to the teaching of claim 6 and a communication system according to the teaching of claim 8.

The main idea of the invention is to use a measurement-based admission control that can be applied e.g. to IEEE 802.11e EDCA-enhanced WLAN systems. The proposed solution can be combined with the QoS capabilities introduced by the IEEE 802.11e standard, that provide to mobile terminals the means to reserve and release radio resources as well as to modify them. The solution is based on the measurement of some important metrics characterizing the radio channel, as specified e.g. by the IEEE 802.11k/D1.2 draft standard.

The resource reservation request, i.e. the so-called ADDTS request message (ADDTS=Add Traffic Stream) sent from a mobile terminal to an access point, contains traffic specifications like e.g. the nominal MSDU size (MSDU=MAC Service Data Unit), the mean data rate or the minimum PHY rate (PHY=Physical Layer).

The admission control decision is concentrated into a functional admission controller, responsible to execute the Channel Admission Control (CAC) algorithm. The admission controller can reside e.g. in a so-called fat access point or in a Wireless Network Controller (WNC). In the following the admission controller will be described as external to the access point, in order to explicitly detail the communication between the access point and the admission controller. In case of colocated access points and admission controller, such communication is internal.

The CAC algorithm takes as input the traffic specifications (TSPEC) describing the to-be-admitted flow, i.e. the so-called TSPEC element, combines it with the measured network load information, i.e. the current channel utilization, and decides whether or not the flow can be admitted without impacting the performance of already admitted flows.

Briefly, the channel admission control process can be described in the following way:

The access point measures the channel utilization Uₘₑₐₛ during the time period of a so-called measurement window (MW). Then, it provides this information to the admission controller, as input for the CAC algorithm.

The admission controller uses the channel utilization and has initial values to build its own internal view of the channel utilization that is called current channel utilization U_{curr}:
Uₘₑₐₛ [symbol] U_{curr}

When the admission controller receives a resource reservation request, i.e. an ADDTS request message, from a mobile terminal, it computes the increase in utilization of the channel requested by the new flow U_{add} as the synthesis of the flow characteristics specified in the TSPEC element:
TSPEC [symbol] U_{add}

The admission controller combines the current channel utilization U_{curr} with the calculated increment of the channel utilization that is called additional channel utilization U_{add} to get the (theoretical) new channel utilization U_{new}, as if the new flow was already admitted:
U_{new}=U_{curr}+U_{add}

The admission controller takes the admission decision by checking if U_{new} does not exceed a given target channel utilization U_{target}, i.e. the maximum acceptable channel utilization. If U_{new} is smaller than U_{target} , the new flow is admitted, otherwise it is rejected:
U_{new}<U_{target} ? [symbol] Decision

When a flow is admitted, the admission controller updates its internal view of the channel utilization, i.e. the current channel utilization U_{curr}, in order to account for the increase in the channel utilization due to the newly admitted flow:
U_{curr}=U_{new}

Further developments of the invention can be gathered from the dependent claims and the following description.

In the following the invention will be explained further making reference to the attached drawings.

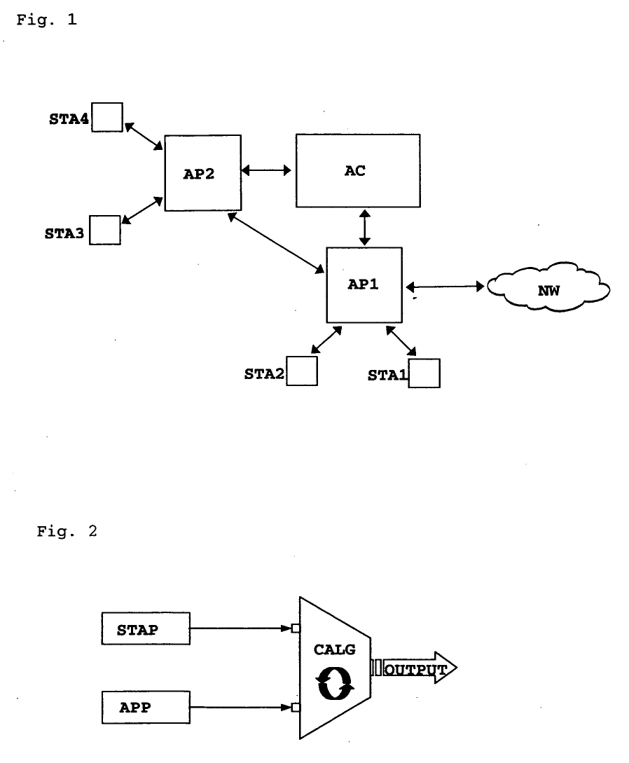

FIG. 1 schematically shows a communication system with several mobile terminals, two access points and one admission controller for carrying out a method for providing admission control for the admission of a mobile terminal to a mobile network according to the invention.

FIG. 2 schematically shows the principle mechanism of the CAC algorithm that is used to carry out a method for providing admission control according to the invention.

A communication system according to the invention is depicted in FIG. 1 and comprises a mobile network that in turn comprises at least one access point AP1, at least two mobile terminals STA1 and STA2 and at least one admission controller AC. In the example described hereafter by means of FIG. 1, there are comprised two access points AP1 and AP2 and four mobile terminals STA1-STA4. Preferably, said communication system additionally comprises at least one connection to a network NW like e.g. the Internet or another mobile network.

The access points AP1 and AP2 are connected to each other e.g. via a backbone system and at least the mobile terminal STA1 is connected to the access point AP1 via a wireless connection. Additionally, the access points AP1 and AP2 are both connected to the access controller AC via a fixed or wireless connection. The mobile terminal STA1 that is connected via a wireless connection to the access point AP1 can by means of the backbone system be further connected via the further access point AP2 to one of the mobile terminals STA3 or STA4 within the same mobile network. Furthermore, this mobile terminal STA1 can also be connected by means of the backbone system and via gateways to devices like e.g. terminals or servers located in a further network NW like e.g. the Internet or another mobile network.

The access points AP1 and AP2 comprise the functionality of an access point of a mobile network, i.e. they provide the possibility for mobile terminals to get connected to a mobile network. Furthermore, the access points AP1 and AP2 comprise means for sending admission requests that are originated by a mobile terminal STA1-STA4 to the admission controller AC and means for receiving admission responses from the admission controller AC.

The mobile terminals STA1-STA4 comprise the functionality of a mobile terminal for a mobile network, i.e. they can be connected to a mobile network by means of an access point AP1 or AP2. Particularly, the mobile terminals STA1-STA4 comprise means for sending admission requests to the access points AP1 or AP2 and for receiving admission responses from the access points AP1 or AP2.

The admission controller AC according to the invention comprises means for receiving admission requests for the admission of a mobile terminal STA1-STA4 to the mobile network, for receiving parameters that characterize the radio channel that shall be used for a connection of the mobile terminal STA1-STA4 to the mobile network, for receiving parameters that characterize the traffic flow of said connection, for controlling the admission based on at least one of said parameters that characterize the radio channel that shall be used for a connection of the mobile terminal STA1-STA4 to the mobile network and on at least one of said parameters that characterize the traffic flow of said connection and for sending a response concerning the admission request towards the mobile terminal STA1-STA4.

In the following, by way of example the method according to the invention is described in detail making reference to FIGS. 1 and 2.

The proposed method for providing channel admission control (CAC) is implemented in a WLAN system according to the IEEE 802.11e standard and is based on the following assumptions and initial considerations:
The mobile terminal STA2 requests a new traffic flow by means of sending a so-called ADDTS request message specifying the so-called TSPEC element to the access point AP1 which in turn forwards the ADDTS request message to the admission controller AC. The TSPEC element shall include, at least, the following parameters: The nominal MSDU size, the required mean data rate Rᵣ, the required minimum PHY rate, and the requested EDCA access category, which is specified in the so-called TS info field. Note that the TSPEC element could also specify the required minimum data rate, which is not essential to the proposed CAC algorithm, but useful to give to a mobile terminal the possibility to renegotiate the desired QoS level when admission is not possible with the current QoS requirements. The ADDTS request message and the TSPEC element are both defined in IEEE 802.11e standard.
The so-called surplus bandwidth allowance explained below is a TSPEC field supposed to be filled by the mobile terminal STA2. However, due to its extremely complicated computation, it is very unlikely, although not impossible, that the mobile terminal STA2 can compute it. In case the surplus bandwidth allowance is not provided by the mobile terminal STA2, the admission controller AC shall compute it, using the algorithm defined here: Draft Supplement to Standard For Telecommunications and Information Exchange Between Systems-LAN/MAN Specific Requirements-Part 11: Wireless Medium Access Control (MAC) and Physical Layer (PHY) specifications: Medium Access Control (MAC) Enhancements for Quality of Service (QoS), IEEE Standard 802.11e D0.8. Alternatively, the surplus bandwidth allowance could be computed by the access point AP1 and provided to the admission controller AC. However, this does not seem to be a good solution. In fact, in this case, the access point AP1 must be able to intercept ADDTS request frames, interpret them, compute the surplus bandwidth allowance on the fly, insert it into a new ADDTS request message and forward it to the admission controller AC.
The metrics of interest are computed over a measurement window (MW) with the duration of the time period T_{W} depending on traffic load and throughput. They are expressed in number of observed successful accesses W_{A}, i.e. successful transmitted packets, instead of in seconds. This number of successful transmitted packets W_{A} can be measured by the access point AP1 based on the total number of transmitted and received acknowledgements ACK. This method has the advantage to avoid lack of data in the case of low traffic and an excessive latency in the case of high load or load spikes.

In a basic embodiment of the invention, only one class of service, i.e. only one so-called EDCA access category, is defined in the so-called QoS basic service set (QBSS) of the system. Despite such simplification, the description details precisely and completely the chosen approach. The useful parameters will be presented, as well as the metrics measured by the access point AP1 and the ones computed by the admission controller AC. Finally the admission control algorithm itself is detailed.

The following definitions of useful static parameters are introduced to the CAC algorithm proposal:
The maximum packet drop probability p_{drop} represents the maximum probability of any packet to be dropped in the radio channel, i.e. the probability that the packet fails to be received within a so-called delay bound. This value is necessary to compute the surplus bandwidth allowance. It is assumed to use a pre-configured value, fixed as a static parameter for the entire basic service set (BSS), i.e. for the admission controller AC. The IEEE 802.11e standard specification proposes to use a value of p_{drop}=10⁻⁸.
The target channel utilization U_{target} represents the target value of utilization that the admission controller AC wants to achieve and that shall not be exceeded within its controlled QoS basic service set. By definition, the value of U_{target} is smaller than 1. The parameter U_{target} is a configurable parameter that can be tuned to adjust the inherent inaccuracy of the CAC algorithm.

In FIG. 2, the principle mechanism of the CAC algorithm CALG according to the invention that can be implemented e.g. in the admission controller AC is depicted. The mobile terminal STA2 delivers to the CAC algorithm CALG the parameters STAP that characterize the traffic flow of the connection from the mobile terminal STA2 to the mobile network and that can be comprised e.g. in the TSPEC element. Furthermore, the access point AP1 delivers to the CAC algorithm CALG the parameters APP that characterize the radio channel that shall be used for the connection, like e.g. information about the radio channel utilization. The result OUTPUT of the CAC algorithm CALG comprises e.g. a decision whether or not the traffic flow is admitted and instructions concerning the access of the mobile terminal STA2 to the radio channel. The result OUTPUT is sent from the admission controller AC in which the CAC algorithm CALG is implemented to the mobile terminal STA2.

In the following, the measurements performed by the access point AP1 that lead to the parameters APP that are provided to the admission controller AC as input for the CAC algorithm CALG are described. As already mentioned, the measured metrics of interest are computed over the time period T_{W} of a measurement window (MW) that is depending on traffic load and throughput and expressed in number of observed successful accesses W_{A}, i.e. successful transmitted packets, instead of in seconds.
The packet loss probability p₁ represents the probability to lose a packet over the wireless medium. It can be derived using both the average packet error probability over the radio channel denoted by pₑ, which can be easily estimated by the access point AP1, and the collision probability denoted by p_{c}, which can be estimated using the following formula:

$${p}_{c} = 1 - {( 1 - \frac{1}{{CW}_{min}} )}^{N - 1}$$
In this formula, CWₘᵢₙ denotes the so-called minimum contention window size and N denotes the number of active mobile terminals in a collision domain, i.e. there are N mobile terminals within the transmission range of each other that have data to send. A packet is lost over the wireless medium whether if it collides or if it suffers from an error on the radio channel. Then, p₁ is given by this equation:
   p₁=pₑ+p_{c}−pₑp_{c}
The packet loss probability p₁ is used by the admission controller AC to compute the surplus bandwidth allowance described below.
The measured channel utilization Uₘₑₐₛ provides an indication of the system load level. Uₘₑₐₛ is one of the main metrics to be measured by the access point AP1. Theoretically it is given by this formula:

$${U}_{meas} = 1 - \frac{{T}_{I}}{{T}_{w}} = \frac{{T}_{B}}{{T}_{w}}$$
In this formula, T_{I} denotes the channel idle time and T_{B} denotes the channel busy time. From a practical standpoint, Uₘₑₐₛ can be derived by the access point AP1 from channel observation, as specified in IEEE 802.11k standard specification. According to the section 11.7.7.6 of the IEEE 802.11k standard specifying the radio resource measurement in 802.11 WLAN networks, the access point AP1 performs the following measurements:
The CCA (CCA=clear channel assessment) idle histogram, i.e. the histogram of the time intervals during which the PHY clear channel assessment detected an idle medium;
The CCA busy histogram, i.e. the histogram of the time intervals during which the PHY clear channel assessment detected a busy medium;
The NAV (NAV=network allocation vector) busy histogram, i.e. the histogram of the time intervals during which the NAV value was set to a positive value.
It must be highlighted that from the CCA histograms it is possible to derive the minimum, maximum and average idle and busy time of the channel during the measurement window. One such histogram, e.g. the CCA busy histogram, might report the probability density function (pdf) denoted b(x) of the number of consecutive busy slots x. From it, the average number of busy slots E(B) can be computed in the following way:

$$E [ B ] = {\sum }_{x = 0}^{∞} x \cdot b ( x )$$
The average number of idle slots E[I] can be computed in a similar way from the CCA idle histogram. The measured channel utilization Uₘₑₐₛ can then be computed using the following formula:

$${U}_{meas} = \frac{E [ B ]}{E [ B ] + E [ I ]}$$
The latter formula is a practical computation of the measured channel utilization Uₘₑₐₛ. The measured channel utilization is measured/computed during the time period of a measurement window and provided to the admission controller AC to be used in the CAC algorithm during the next measurement window.

To perform admission control, the admission controller AC computes a number of metrics. The input data used for this computation are provided by both the access point AP1 and the mobile terminal STA2 involved in the process. The access point AP1 provides to the admission controller AC the parameters APP that characterize the radio channel that shall be used for the connection like e.g. the measured channel utilization Uₘₑₐₛ, the packet loss probability p₁ and the duration of the measurement window denoted T_{W}. The mobile terminal STA2 provides to the admission controller AC by means of the ADDTS request message the parameters STAP that characterize the traffic flow of the connection from the mobile terminal STA2 to the mobile network, i.e. the description of the to be admitted flow comprised e.g. in the TSPEC element.

The metrics computed by the admission controller AC are listed and described below:
The number of expected accesses A to the mobile network that the requesting mobile terminal STA2 would have attempted if it had been active during the past measurement window of duration T_{W} is computed by the admission controller AC by means of the following formula:

$$A = ( \frac{{R}_{min}}{{S}_{MSDU}} \cdot {T}_{w} )$$
In this formula, Rₘᵢₙ denotes the minimum data rate of the new flow and S_{MSDU} denotes the nominal MSDU size. These two values are specified in the TSPEC element carried by the ADDTS request message, and the duration of the past measurement window T_{W} is provided by the access point AP1. The number of expected accesses A will then be used for the computation of the so-called surplus bandwidth allowance, as will be explained below.
The medium time parameter T_{M} is defined by the IEEE 802.11e standard and represents the time for the channel utilization of a single flow. It can be derived by the admission controller AC from the flow characteristics specified in the TSPEC element. The medium time T_{M} can be obtained in the following way:

$${T}_{M} = SBA \cdot ( \frac{{R}_{r}}{{S}_{MSDU}} ) \cdot {T}_{F}$$
In this formula,
   Rᵣ is the required mean data rate as specified in the TSPEC element,
   The nominal MSDU size S_{MSDU} is also specified by the requesting mobile terminal STA2 in the TSPEC element carried in the ADDTS request frame,
   The frame exchange time T_{F} is given by the transmission time of a frame at the minimum PHY rate of the mobile terminal, plus the so-called short interframe space (SIFS) time interval and the acknowledgement (ACK) transmission time,
   The surplus bandwidth allowance factor SBA specifies the excess allocation of time used to bound the number of dropped packets of the application. This value accounts for retransmissions due to channel errors, collisions, and MAC and PHY overheads that are not specified in the rate information. In other words, it represents the ratio of the actual over-the-air time that the scheduler should allocate for the transmission of MSDU units at the required rates to the time that would be necessary at the minimum PHY rate if there were no packet losses. As such, it must be greater than unity. It can be calculated once we know the maximum packet drop probability, p_{drop}, specified by the requesting mobile terminal, the packet loss probability over the wireless medium p₁, provided by the access point AP1 and the number of expected access attempts A within a specific time frame, which is the time period of a measurement window T_{W} in this case. A procedure to perform this calculation is presented in the Annex H.3.2 of this document: Draft Supplement to Standard for Telecommunications and Information Exchange Between Systems-LAN/MAN Specific Requirements-Part 11: Wireless Medium Access Control (MAC) and Physical Layer (PHY) specifications: Medium Access Control (MAC) Enhancements for Quality of Service (QoS), IEEE Standard 802.11e DO.8.

The IEEE 802.11e specification just mentioned also provides full detailed indications about the computation of the medium time parameter T_{M}. The medium time parameter T_{M} is computed by the admission controller AC and used in the CAC algorithm as estimation of the increase in utilization of the channel requested by the new flow U_{add}:
Tₘ [symbol] U_{add}
An estimation of the current channel utilization U_{curr} of the radio channel is built and maintained by the admission controller AC during the duration of a measurement window T_{W}. This is done by combining the measured channel utilization Uₘₑₐₛ at the end of the previous measurement window as provided by the access point AP1 with the sum of the additional channel utilization U_{add} consumed by each newly admitted flow. The duration of the past measurement window T_{W} is also required for this estimation. At the beginning of a new measurement window, the admission controller AC sets the value of the current channel utilization U_{curr} to the value of the measured channel utilization Uₘₑₐₛ provided by the access point AP1. At that time, the current channel utilization U_{curr} reflects precisely the current state of the radio channel. For each during the current measurement window newly accepted flow, the admission controller AC computes the increase in utilization of the channel by the new flow U_{add} and updates U_{curr} in order to take into account the new active flow. The current channel utilization U_{curr} can be computed in the following way:
   U_{curr}+U_{add} [symbol] U_{curr}
At the end of a measurement window, U_{curr} is refreshed to the new measured channel utilization Uₘₑₐₛ provided by the access point AP1, and the whole process restarts.

The next section details the proposed CAC algorithm CALG. It massively uses the metrics defined in the previous sections.

The basic principle of the CAC algorithm CALG is the following: The admission controller AC builds and maintains the estimation of the current channel utilization U_{curr} and uses it to check whether the resources needed for the increase in utilization of the channel by the new flow U_{add} are available or not.

The CAC algorithm CALG is executed by the admission controller whenever an ADDTS request message is received, i.e. the reception of such an ADDTS request message acts as a triggering event. The CAC algorithm CALG takes the following metrics as input:
The current channel utilization U_{curr} maintained by the admission controller AC, as detailed in the previous section.
The increase in utilization of the channel requested by the new flow U_{add} computed by the admission controller AC by means of the TSPEC element, as detailed in the previous section.

Given these input data, the admission controller AC computes the new (theoretical) channel utilization U_{new} that it would have if the new flow was admitted:
U_{new}=U_{curr}+U_{add}

Once the new channel utilization U_{new} is calculated, the admission controller AC can take its admission decision by checking if the new channel utilization U_{new} does not exceed a given threshold, the target channel utilization U_{target}. The target channel utilization U_{target} represents the target value of utilization that the admission controller AC wants to achieve within its controlled QBSS set.

The admission controller AC can take three possible decision: Accept the new flow and reserve the resources requested, reject it or initiate a renegotiation by proposing a less resource consuming TSPEC element for the flow.

The admission controller AC will accept the admission of the new flow if:
U_{new}<U_{target}
In that case, the admission controller AC updates the current channel utilization U_{curr} in order to take into account the newly accepted flow:
U_{curr}=U_{new}
In the ADDTS response message, the admission controller AC indicates as medium time parameter T_{M} in the TSPEC element the increase in utilization of the channel requested by the new flow U_{add} computed for the flow.

The admission controller AC will try to renegotiate the admission of the new flow with the mobile terminal STA2 if:
U_{new}>U_{target}
If there is a value of data rate R′ᵣ greater than or equal to the required minimum data rate Rₘᵢₙ of the new flow specified by the mobile terminal STA2, this value of data rate R′ᵣ can replace the mean data rate Rᵣ in the computation of the increase in utilization of the channel requested by the new flow U_{add}, i.e. in the computation of the medium time parameter T_{M}, if the following inequation is true:
U′_{new}<U_{target}
In this formula, U′_{new} denotes the new channel utilization that has been derived by means of using the value of data rate R′ᵣ instead of the mean data rate Rᵣ in the computation of the increase in utilization of the channel requested by the new flow U_{add}. During the renegotiation process, the current channel utilization U_{curr} is not updated with the parameters of the requested flow, and the resources are not reserved.

The admission controller AC will reject the admission of the new flow for any mean data rate Rᵣ greater than or equal to the minimum data rate Rₘᵢₙ specified by the by the mobile terminal STA2, if:
U_{new}>U_{target}
Clearly, in case of rejection, the current channel utilization U_{curr} is not updated with the parameters of the requested flow.

In a preferred embodiment, the described admission control mechanism is extended to a more realistic case, where multiple classes of traffic/service, i.e. multiple EDCA access categories are defined like e.g. Voice, Video, and Data. The main difference is that now the most important metrics must be measured/computed taking into account the different access categories.

In the following, the modifications requested in the definition of the useful parameters, as well as in the metrics measured by the access point AP1 and the ones computed by the admission controller AC are described. Also, the admission control decision must take into account the existence of the different EDCA access categories.

In the case of multiple classes of service, the static parameters evolve as follows:
The maximum packet drop probability p_{drop} rests unchanged w.r.t. its definition given in the basic embodiment, because it is a value that applies to the whole QBSS set and does not depend on the different classes of service.
The target channel utilization U_{target}^{ACi} depends on the access category ACi. When several classes of service, i.e. EDCA access categories, are defined, the admission controller decides by initial configuration how it wants to share the available bandwidth in its QBSS set among the different access categories. For example, it could choose to reserve 70% of the total available bandwidth to VoIP traffic (VoIP=Voice over Internet Protocol), 20% to video streaming traffic, and the rest (10%) for best-effort data traffic, like e.g. web-browsing. Obviously, the following relation describes the overall target channel utilization U_{target}:

$${\sum }_{\{ ACi \}} {U}_{target}^{ACi} = {U}_{target}$$

The measurements performed by the access point AP1 are also impacted by the presence of multiple classes of service:
The packet loss probability per access category pₗ^{ACi} depends on the collision probability p_{c}^{ACi} which in turns depends on the minimum contention window size CWₘᵢₙ^{ACi}. Since the contention window size differs between the different EDCA access categories, the collision probability also depends on the different EDCA access categories. Thus, it must be computed for each access category, using the corresponding CWₘᵢₙ^{ACi} in the following way:

$${p}_{c}^{ACi} = 1 - {( 1 - \frac{1}{{CW}_{min}^{ACi}} )}^{N - 1}$$
Therefore, also the packet loss probability differs among the different EDCA access categories:
   pₗ^{ACi}=pₑ+p_{c}^{ACi}−pₑp_{c}^{ACi}
The access point AP1 needs to measure the channel utilization Uₘₑₐₛ^{ACi} per access category. This can be easily obtained by using the mechanisms defined in the IEEE 802.11k standard. In fact, the IEEE 802.11k draft standard specifically refers to QoS measurements for different EDCA access categories as described here: Section 11.7.7.6 of Draft Supplement to Standard for Telecommunication and Information Exchange between Systems-LAN/MAN Specific Requirements-Part 11: Wireless Medium Access Control (MAC) and Physical Layer (PHY) Specifications: Specification for Radio Resource Measurement, IEEE Standard 802.11k D0.8, December 2003. An alternative solution might be to resort to a Montecarlo approach, by selecting a subset of received/sent packets, e.g. about 15%-20% of the total packets, and perform the estimation on such reduced subset. In any case, the following relation must be respected by definition:

$${\sum }_{\{ ACi \}} {U}_{meas}^{ACi} = {U}_{meas}$$

Some of the metrics computed by the admission controller AC are impacted by the effect of prioritization among the different classes of service:
The number of expected accesses A is not impacted by the presence of several EDCA access categories and its definition rests unchanged compared with the case of only one EDCA access category that is described above.
The medium time parameter T_{M}^{ACi} and therefore also the increase in utilization of the channel requested by the new flow U_{add}^{Aci} depend on the access category Aci because the surplus bandwidth allowance is computed using the packet loss probability pₗ^{ACi} that is dependent on the access category ACi. The computation of the medium time parameter T_{M}^{ACi} is straightforward.
The current channel utilization U_{curr}^{ACi} is estimated by the admission controller AC dependent on the access category Aci. The definition that follows is directly derived from the one described above, knowing that a to-be-admitted flow is always mapped on an access category ACi:

$${U}_{curr}^{ACi} + {U}_{add}^{ACi} ⇒ {U}_{curr}^{ACi}$$

To extend the proposed solution for the CAC algorithm CALG to the case where several EDCA access categories are defined, the CAC algorithm CALG must take into account the traffic differentiation. To do so, the following redefined metrics must be used: The measured channel utilization Uₘₑₐₛ^{ACi} per access category from the access point AP1, the target channel utilization U_{target}^{ACi} per access category, the medium time parameter T_{M}^{ACi} per access category and the current channel utilization U_{curr}^{ACi} per access category.

The CAC algorithm CALG can be easily derived from the basic case described above using the redefined metrics for the case of multiple access categories. The main idea is that now the admission controller AC performs admission control per EDCA access category, keeping an indication of the current channel utilization U_{curr}^{ACi} for each access category ACi.

At the end of each measurement window, the access point AP1 provides to the admission controller AC the measured channel utilization Uₘₑₐₛ^{ACi} for each access category ACi.

When an ADDTS request message is received by the admission controller AC, the admission controller AC identifies to which access category ACi the new flow maps by means of the so-called TS Info field of the TSPEC element, and perform exactly the same process as described for the CAC algorithm CALG in case of only one access category ACi, now using the metrics for multiple access categories, i.e. the admission controller AC computes the new (theoretical) channel utilization U_{new}^{ACi} that it would have if the new flow were admitted in the requested access category ACi according to the following formula:
U_{new}^{ACi}=U_{curr}^{ACi}+U_{add}^{ACi}

The admission controller AC can now take its decision by checking if the new (theoretical) channel utilization U_{new}^{ACi} does not exceed the target channel utilization U_{target}^{ACi} of the considered access category ACi. Similar to the basic case with only one access category ACi, the admission controller can accept, reject or renegotiate the flow.

The admission controller AC will accept the admission of the new flow if the following inequation is true:
U_{new}^{ACi}<U_{target}^{ACi}
In that case, the admission controller AC updates the corresponding current channel utilization U_{curr}^{ACi} in the following way in order to take into account the newly accepted flow:
U_{curr}^{ACi}=U_{new}^{ACi}
In the ADDTS response message sent to the mobile terminal STA2, the admission controller AC indicates as medium time parameter T_{M}^{Aci} in the TSPEC element the increase in utilization of the channel requested by the new flow U_{add}^{ACi} computed for the flow.

The admission controller AC will try to renegotiate the admission of the new flow with the mobile terminal STA2 if:
U_{new}^{ACi}>U_{target}^{ACi}
If there is a value of data rate R′ᵣ greater than or equal to the required minimum data rate Rₘᵢₙ of the new flow specified by the mobile terminal STA2, this value of data rate R′ᵣ can replace the mean data rate Rᵣ in the computation of the increase in utilization of the channel requested by the new flow U_{add}^{ACi}, i.e. in the computation of the medium time parameter T_{M}^{ACi}, if the following inequation is true:
U′_{new}^{ACi}<U_{target}^{ACi}
In this formula, U′_{new}^{ACi} denotes the new channel utilization that has been derived by means of using the value of data rate R′ᵣ instead of the mean data rate Rᵣ in the computation of the increase in utilization of the channel requested by the new flow U_{add}^{ACi}. During the renegotiation process, the current channel utilization U_{curr}^{ACi} is not updated with the parameters of the requested flow, and the resources are not reserved.

The admission controller AC will reject the admission of the new flow for any mean data rate Rᵣ greater than or equal to the minimum data rate Rₘᵢₙ specified by the by the mobile terminal STA2, if:
U_{new}^{ACi}>U_{target}^{ACi}
Clearly, in case of rejection, the current channel utilization U_{curr}^{ACi} is not updated with the parameters of the requested flow.

1. A method for providing admission control for the admission of a mobile terminal to a mobile network wherein said admission control is based on at least one parameter that characterizes the radio channel that shall be used for a connection of the mobile terminal to the mobile network and on at least one parameter that characterizes the traffic flow of said connection.

2. A method according to claim 1, wherein at least one of said at least one parameter that characterizes the radio channel is used to derive the radio channel utilization of said radio channel.

3. A method according to claim 1, wherein at least one of said at least one parameter that characterizes the radio channel and at least one of said at least one parameter that characterizes the traffic flow of said connection are used to derive the additional radio channel utilization caused by said traffic flow of said connection.

4. A method according to claim 3, wherein said admission control is based on a comparison of the sum of said radio channel utilization and said additional radio channel utilization with a target channel utilization.

5. A method according to claim 1, wherein the at least one parameter that characterizes the radio channel, the at least one parameter that characterizes the traffic flow of said connection, the radio channel utilization and/or the additional radio channel utilization are given or derived for different classes of traffic.

6. An admission controller for providing admission control for the admission of a mobile terminal to a mobile network, wherein the admission controller comprises means for receiving admission requests for the admission of the mobile terminal to the mobile network, for receiving parameters that characterize the radio channel that shall be used for a connection of the mobile terminal to the mobile network, for receiving parameters that characterize the traffic flow of said connection, for controlling the admission based on at least one of said parameters that characterize the radio channel that shall be used for a connection of the mobile terminal to the mobile network and on at least one of said parameters that characterize the traffic flow of said connection and for sending a response concerning the admission request towards the mobile terminal.

7. An admission controller according to claim 6, wherein said admission controller is colocated with an access point of the mobile network.

8. A communication system comprising at least one mobile terminal and at least one access point (AP1) wherein said communication system comprises at least one admission controller according to claim 6.
